(19) United States
(12) Patent Application Publication
(10) Pub. No.: US 2024/0412141 A1
(43) Pub. Date: Dec. 12, 2024

(54) ESTIMATION SYSTEM, ESTIMATION METHOD, AND PROGRAM

(71) Applicant: NIPPON TELEGRAPH AND TELEPHONE CORPORATION, Tokyo (JP)

(72) Inventors: Xiaoxi ZHANG, Tokyo (JP); Masahiro SOTOMA, Tokyo (JP); Machiko SHINOZUKA, Tokyo (JP); Midori KAWADA, Tokyo (JP); Minako HARA, Tokyo (JP)

(21) Appl. No.: 18/699,422

(22) PCT Filed: Nov. 11, 2021
(86) PCT No.: PCT/JP2021/041584

§ 371 Date: Apr. 8, 2024

(51) Int. Cl. G06Q 10/0635; G06Q 10/0637

(52) U.S. Cl. CPC G06Q 10/0635; G06Q 10/06375

(57) ABSTRACT

An estimation system including: an industry influence calculation unit configured to calculate a production influence amount exerted on a second industry by a change based on change information indicating a change in a first industry in which the change has been observed, a production amount in a second industry to which an evaluation target company belongs, and production inducement information from the first industry to the second industry; and a business influence calculation unit configured to calculate a sales influence amount exerted on the evaluation target company by the change based on the production influence amount.

### TECHNICAL FIELD

The present invention relates to a technique for analyzing influence of world events on a company.

### BACKGROUND ART

In modern society, in addition to the progress of globalization, Internet technology is developing, and a lot of information is coming out from various media, SNS, and the like every day. It is important to analyze and utilize such information to catch events that may affect corporate management as soon as possible, consider impact of the events, and reflect the events in corporate strategy planning and decision-making.

In existing technology, there is a method of extracting the latest topics from news information, analyzing a causal correlation between events by utilizing natural language processing technology, and analyzing an influence of each topic event on a company (Non Patent Literature 1).

### CITATION LIST

### Non Patent Literature

Non Patent Literature 1: xenoBRAIN, https://special-edition.xenobrain.jp/scenario-https://xenobrain.jp/articles/nikkekog/9b4dacfcdcbb32b061c6c28e0f63ec96.

Non Patent Literature 2: Inter-Industry Correlation Table 2015 Inter-Industry Correlation Table 2015 Input Coefficient Table, Inverse Matrix Coefficient Table.

### SUMMARY OF INVENTION

### Technical Problem

However, the existing technology is based on correlation analysis by language analysis using text data such as news, and it is considered that there is information bias. In addition, language analysis processing using a large amount of text data is required in advance, and it is difficult for a company or evaluator who is not specialized in language analysis to construct an analysis frame.

The present invention has been made in view of the above points, and an object of the present invention is to provide a technique for simply and quantitatively estimating the influence of world events on a company.

### Solution to Problem

According to the disclosed technology, there is provided an estimation system including:

an industry influence calculation unit configured to calculate a production influence amount exerted on a second industry by a change on the basis of change information indicating a change in a first industry in which the change has been observed, a production amount in a second industry to which an evaluation target company belongs, and production inducement information from the first industry to the second industry; and

a business influence calculation unit configured to calculate a sales influence amount exerted on the evaluation target company by the change on the basis of the production influence amount.

### Advantageous Effects of Invention

According to the disclosed technology, it is possible to easily and quantitatively estimate the influence of world events on a company.

### BRIEF DESCRIPTION OF DRAWINGS

FIG. 1 is a configuration diagram illustrating an estimation system according to an embodiment of the present invention.

FIG. 2 is a flowchart illustrating operation of the estimation system.

FIG. 3 is a diagram illustrating an image of an inter-industry coefficient.

FIG. 4 is a diagram illustrating a hardware configuration example of the estimation system.

### DESCRIPTION OF EMBODIMENTS

Hereinafter, an embodiment of the present invention (present embodiment) will be described with reference to the drawings. The embodiment described below is merely an example, and embodiments to which the present invention is applied are not limited to the following embodiment.

### System Configuration Example

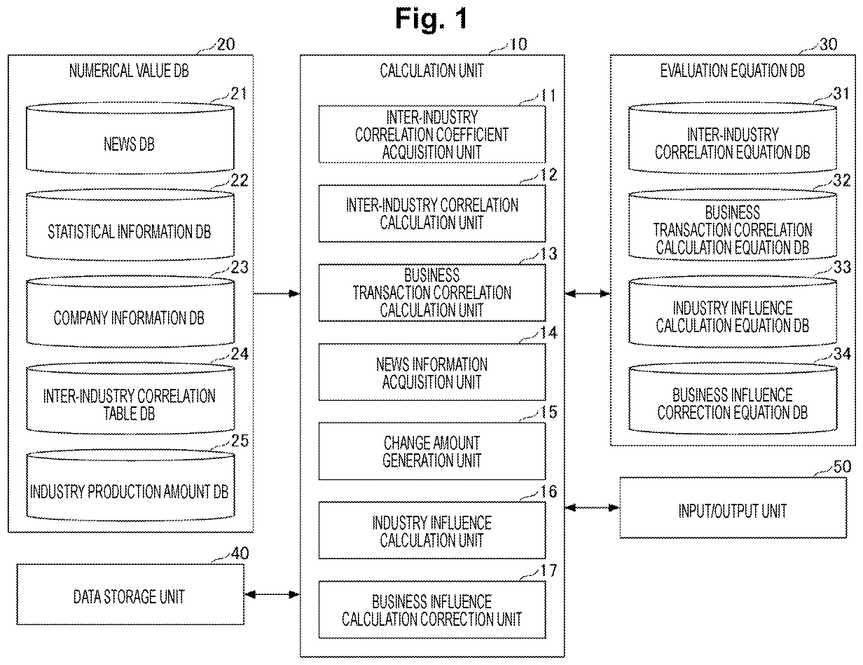

FIG. 1 illustrates a configuration example of an estimation system according to the present embodiment. As illustrated in FIG. 1, the estimation system according to the present embodiment includes a calculation unit 10, a numerical value DB 20, an evaluation equation DB 30, a data storage unit 40, and an input/output unit 50.

The calculation unit 10 includes an inter-industry correlation coefficient acquisition unit 11, an inter-industry correlation calculation unit 12, a business transaction correlation calculation unit 13, a news information acquisition unit 14, a change amount generation unit 15, an industry influence calculation unit 16, and a business influence calculation correction unit 17.

The numerical value DB 20 includes a news DB 21, a statistical information DB 22, a company information DB 23, an inter-industry correlation table DB 24, and an industry production amount DB 25.

In addition, the evaluation equation DB 30 includes an inter-industry correlation equation DB 31, a business transaction correlation calculation equation DB 32, an industry influence calculation equation DB 33, and a business influence correction equation DB 34.

An operation example of each unit, specific examples of the equations, and the like will be described later. Equations 1, 2, 3, and 4 to be described later are stored in the inter-industry correlation equation DB 31, the business transaction correlation calculation equation DB 32, the industry influence calculation equation DB 33, and the business influence correction equation DB 34, respectively. Each equation stored in a DB is, for example, an equation using a variable. In a case where calculation is performed using the corresponding equation, the calculation can be performed by reading the equation from the DB and substituting a necessary value into the variable portion. As a coefficient used in an equation, a coefficient stored in the data storage unit 40 can be used.

The estimation system may include one device (computer) or may include a plurality of devices. For example, the numerical value DB 20 and the calculation unit 10 may be separate devices. In a case where the numerical value DB 20 and the calculation unit 10 are separate devices, the calculation unit 10 may be referred to as an “estimation system ”.

### Operation Example of System

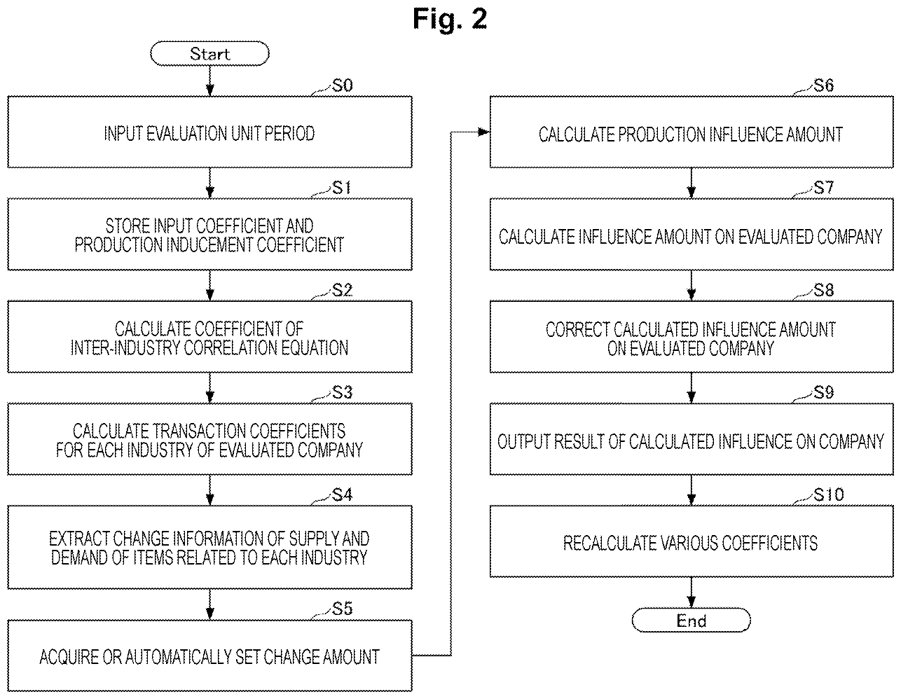

Operation of the estimation system will be described with reference to the flowchart in FIG. 2. An evaluator inputs an evaluation unit period from the input/output unit 50, and the calculation unit 10 executes processing for estimation according to the following flow. The estimation result is output from the input/output unit 50 and shown to the evaluator. A basic processing flow will be described below, and a specific example will be described later.

### S0 (Step 0)

In S0, the evaluator inputs the evaluation unit period from the input/output unit 50.

### S1

In S1, the inter-industry correlation coefficient acquisition unit 11 of the calculation unit 10 acquires an input coefficient and a production inducement coefficient from the inter-industry correlation table DB 24 of the numerical value DB 20, and stores the input coefficient and the production inducement coefficient in the data storage unit 40.

### S2

In S2, the inter-industry correlation calculation unit 12 of the calculation unit 10 acquires sales information for each evaluation unit period of the evaluation target company from the company information DB 23 of the numerical value DB 20, acquires production amount information for each industry in the corresponding period from the industry production amount DB 25, calculates a coefficient of an inter-industry correlation equation that can most fit these past data using a statistical method, and stores the coefficient in the data storage unit 40.

### S3

In S3, the business transaction correlation calculation unit 13 of the calculation unit 10 acquires transaction amount information of the company from the company information DB 23 of the numerical value DB 20, acquires the transaction amount information for each industry in the corresponding period from the industry production amount DB 25, and acquires a business transaction correlation calculation equation from the evaluation equation DB 30. The business transaction correlation calculation unit 13 calculates a transaction correlation with each industry of the evaluation target company using these pieces of information and the business transaction correlation calculation equation, and stores the calculation result in the data storage unit 40.

### S4

In S4, the news information acquisition unit 14 uses news information acquired from a news information DB 21 and classifies the news for each industry in accordance with the industries of the inter-industry correlation table used in S1, and extracts change information regarding the supply and demand of products and the like related to each industry.

### S5

In S5, the change amount generation unit 15 acquires the change amount or automatically sets the change amount in several stages on the basis of the information acquired by the news information acquisition unit 14.

### S6

In S6, the industry influence calculation unit 16 calculates a production influence amount on the industry to which the evaluation target company belongs based on the inter-industry correlation coefficient stored in the data storage unit 40, the production amount of the industry to which the evaluation target company belongs, and the above-described change amount.

### S7

In S7, the business influence calculation correction unit 17 calculates the influence amount on the evaluation target company based on the production influence amount calculated in S6 and the inter-industry correlation equation. Note that the business influence calculation correction unit 17 may include a business influence calculation unit, and the business influence calculation unit may perform the processing of S7.

### S8

In S8, the business influence calculation correction unit 17 refers to the transaction correlation information with each industry of the evaluation target company calculated by the business transaction correlation calculation unit 13, and corrects the influence amount on the evaluation target company calculated in S7.

### S9

In S9, the input/output unit 50 outputs the calculated influence amount on the company and shows the influence amount to the evaluator.

### S10

In S10, after the evaluation period ends, the business influence calculation correction unit 17 collates the calculated influence amount on the company with the actual value of the influence amount, and recalculates various coefficients so as to better fit the actual value. The recalculated coefficients can be used to estimate a future influence amount.

### EXAMPLE

Due to the influence of COVID-19, supply and demand are greatly changing in various industries. Hereinafter, as a specific operation example of the estimation system described above, an example of estimating the influence on Company A due to an increase in demand for electronic information devices such as personal computers due to an increase in telework rate will be described. Hereinafter, an example will be described in the order of the steps illustrated in FIG. 2.

### S0

In S0, an evaluator, from the input/output unit 50, inputs one month as an evaluation unit period.

### S1

In S1, the inter-industry correlation coefficient acquisition unit 11 acquires a 2015 Japan inter-industry correlation table DB (Non-Reference Document 2) from the inter-industry correlation table DB 24, reads the inter-industry correlation coefficients (input coefficient and production inducement coefficient) using the inter-industry correlation table, and records the read inter-industry correlation coefficients in the data storage unit 40.

Specifically, the inter-industry correlation coefficient acquisition unit 11 records an input coefficient (input coefficient table) for each industry as an input coefficient R_demand_{(i,j)} in the data storage unit 40, and records final demand production inducement information (inverse matrix coefficient table) as a production inducement coefficient R_{(i,j)} in the data storage unit 40. Here, i and j represent industry sectors.

Note that the input coefficient indicates the size of the amount of raw materials, fuel, and the like input for production. More specifically, R_demand_{(i,j)} indicates an input coefficient from the industry sector i to the industry sector j (a ratio of an input amount to the industry sector j to a production amount of the industry sector i). Note that the “industry sector” may be referred to as an “industry”.

The production inducement coefficient is a coefficient indicating how much production of which industry occurs in a case where there is a final demand in a certain final demand sector. The production inducement coefficient R_{(i,j)} is a coefficient indicating a production increase in the industry sector j generated with respect to the final demand in the industry sector i.

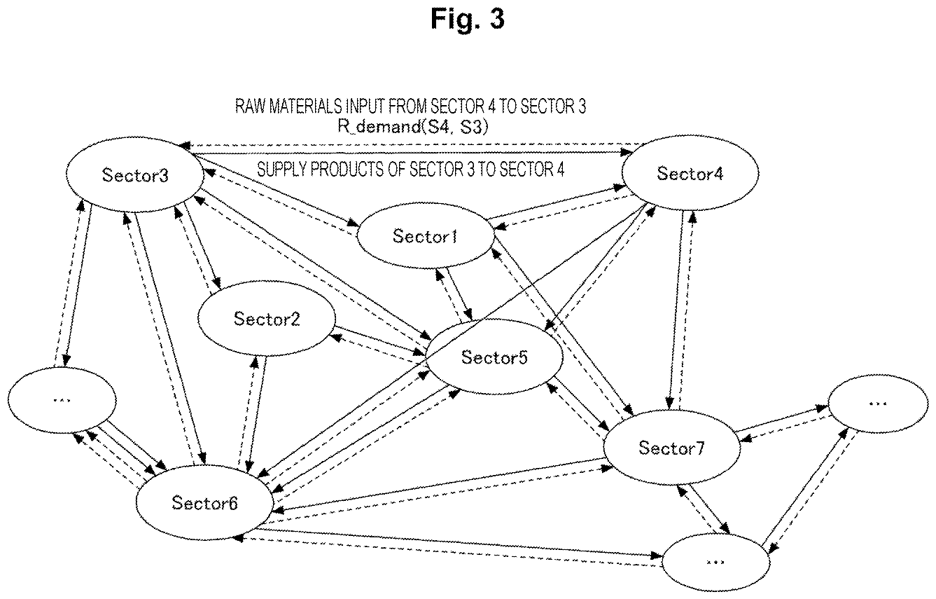

FIG. 3 illustrates an image of an industry correlation coefficient. As illustrated in FIG. 3, various industry sectors exist, and are connected by a correlation of input of raw material costs and the like from a certain industry sector to other industry sectors, supply of products from other industry sectors to meet demand in a certain industry sector, and the like. For example, FIG. 3 illustrates R_demand_{(S4,S3)} as the input of the raw material cost from a sector 4 to a sector 3. In addition, the supply of products of the sector 3 to the sector 4 is illustrated.

### S2

In S2, on the basis of the information acquired from the company information DB 23 and the industry production amount DB 25, the inter-industry correlation calculation unit 12 generates a business transaction correlation calculation equation representing the correlation between the past sales fluctuation of the evaluation target company and the production amount fluctuation of the industry to which the company belongs, calculates a coefficient, and records the coefficient in the data storage unit 40.

In the present embodiment targeting company A, the inter-industry correlation calculation unit 12 performs fitting of past data to generate the following correlation equation (Equation 1) representing a correlation between monthly sales of the company A and production amount of the industry sector 3 to which the company A belongs in a certain past period, calculates coefficients a and b, and records the coefficients a and b in the data storage unit 40.

$${Sales}_{( A , t )} = a + b \times {PV}_{( S 3 , t )} \qquad ( Equation 1 )$$

In Equation 1, Sales_{(A,t)} indicates sales of company A in a certain month t, PV_{(S3,t)} indicates a production amount of the sector 3 in the month t, and a and b are coefficients. Here, for example, it is assumed that a is calculated to be 0.0005 and b is calculated to be 0.01.

### S3

In S3, the business transaction correlation calculation unit 13 classifies companies having a transaction correlation with the evaluation target company into industries in accordance with industry classification (industry sector classification) used in S1, sums up transaction amounts of the companies belonging to the industry and the evaluation target company within the unit evaluation period for each industry by using the business transaction correlation calculation equation (Equation 2), calculates a ratio of the total transaction amount to the total transaction amount of the company, and stores the ratio in the data storage unit 40.

In the present embodiment, each company having a transaction correlation with the company A is classified into an industry, and for each industry, the ratio of the total monthly transaction amount with the company A to the total transaction amount of the company A is calculated and recorded by Equation 2.

$${R\_TV}_{( i t )} = {\sum }_{1} {}_{}^{c} {TV}_{( c \_ i , t 〉}^{} / {TV}_{( t )} \qquad ( Equation 2 )$$

In Equation 2, R_TV_{(i,t)} represents a ratio of the transaction amount between company A and industry i in month t. c represents a company, and Σₗ^{c}TV_{(c_i,t)} is a value obtained by summing the transaction amount with the company A in the month t for the industry i across companies that have transactions with the company A. TV₍ₜ₎ is the total transaction amount of company A in month t.

### S4, S5

In S4, the news information acquisition unit 14 extracts, for each industry, change information regarding the supply and demand of items related to the industry from information such as news in accordance with the industry in the inter-industry correlation table used in S1. In S5, the change amount generation unit 15 uses change information regarding the supply or demand of a certain item in a case where the amount of change can be read from news or the like, and automatically sets the change amount in several stages in a case where the quantitative information cannot be read.

In the present embodiment, it is assumed that the news information acquisition unit 14 and the change amount generation unit 15 acquire information indicating that, based on the news information, the demand for personal computers will increase 1.3 times as the telework rate increases. In the present embodiment, a personal computer is a product of the industry sector 4, and a 1.3 times increase in the demand for personal computers means a 1.3 times increase in the production demand of the industry sector 4. The change amount generation unit 15 acquires “1.3 times” as the change amount.

### S6

In S6, in a case where the above change occurs, the industry influence calculation unit 16 calculates the industry influence amount based on the inter-industry correlation coefficient recorded in S1 and the production amount of the industry to which the company belongs.

As described above, in the present embodiment, the demand increase is 1.3 times in the industry sector 4. The industry influence calculation unit 16 uses this value and the production inducement coefficient R_{(i,j)} recorded in S1 to calculate, in Equation 3 below, the amount of production influence amount on industry sector 3 to which the company A belongs due to the above demand increase.

$$( Equation 3 )$$

$${PV}_{( S 3 , t )}^{′} = {PV}_{( S 3 , t )} \times {Change}_{( S 4 , t )} \times {R}_{( S 4 , S 3 )} = 10 trillion yen \times 1.3 \times 0.22 = 2.86 trillion yen$$

PV′_{(S3,t)} is the industry production influence amount on industry sector 3 in month t. PV_{(S3,t)} is the production amount of the industry sector 3 in the month t. Change_{(S4,t)} is a demand change amount in the industry sector 4 in the month t. R_{(S4,S3)} is a production inducement coefficient from the industry sector 4 to the industry sector 3.

### S7

In S7, the business influence calculation correction unit 17 estimates the influence amount of the change on the company based on the change (production influence amount) in the entire industry to which the evaluation target company belongs using the correlation equation between the sales fluctuation of the evaluation target company and the production amount fluctuation of the affiliated industry recorded in S2.

In the present embodiment, the business influence calculation correction unit 17 calculates the sales influence amount on the company A due to an increase in demand of the industry sector 4 by the following Equation on the basis of the influence amount of the increase in demand of the industry sector 4 on the industry sector 3 by using the coefficients a and b obtained by the above Equation (1).

$${Sales}_{( A , t )}^{′} = a + b \times {PV}_{( S 3 , t 〉}^{′} = 0.0005 + 0.01 \times 2.86 trillion yen = 291 billion yen$$

Sales′_{(A,t)} indicates the sales influence amount on the company A in the month t based on the production influence amount on the industry sector 3.

### S8

In S8, the business influence calculation correction unit 17 corrects the influence amount on the target company calculated in S7 by using the transaction correlation information and the like of the evaluation target company recorded in S3.

Using the inter-industry coefficient (input coefficient) between the industry sector 3 and the industry sector 4 as viewed from the inter-industry correlation table and the correlation coefficient between the company A and the industry sector 4 as viewed from the company transaction information, the sales influence amount of the company A calculated in S7 is corrected by the following Equation (4).

That is, in a case where the correlation between the company A and the industry sector 4 as viewed from the company information is a stronger correlation than the correlation (input coefficient) between the industry sector 3 and the industry sector 4 as viewed from the inter-industry correlation table, it is considered that a change in supply and demand in the industry sector 4 has a stronger influence on the company A, and thus, correction is performed.

$$\begin{matrix}{Sales}_{( A , t )}^{″} = {Sales}_{( A , t )}^{′} \times ( {R\_TV}_{( S 4 , t 〉} / {R\_demand}_{( S 4 , S 3 )} ) \\ = 291 billion yen \times ( 0.24 / 0.2 ) = 349.2 billion yen\end{matrix} \qquad ( Equation 4 )$$

Sales″_{(A,t)} is a correction amount of the influence on sales of Company A in month t. R_TV_{(S4,t)} is the ratio of the transaction amount of Company A with industry sector 4 to the total transaction amount of Company A.

R_demand_{(S4,S3)} is an input coefficient from the industry sector 4 to the industry sector 3 to which the Company A belongs.

### S9

In S9, the input/output unit 50 outputs an estimated value of the influence amount of a certain event on the target company. In the present embodiment, the above “349.2 billion yen” is output as the sales influence amount on the company A due to the increase in demand for personal computers and the like.

### S10

In S10, the business influence calculation correction unit 17 compares the actual value of the influence amount on the target company afterward with the estimated value by the present system, and automatically performs correction as needed when a deviation occurs. As a result, it is possible to improve the estimation accuracy of the business influence. For the correction, for example, the coefficients (for example, a and b) are corrected so that the estimated value matches the actual result. In the present embodiment, afterward, after the numerical value of the actual sales influence amount on the company A appears, the actual value is accumulated, and the correlation with the estimated value using the present method is corrected.

### Device Configuration Example

The estimation system according to the present embodiment can be achieved by, for example, causing a computer to execute a program. This computer may be a physical computer or may be a virtual machine on a cloud.

That is, the estimation system can be achieved by executing a program corresponding to the processing performed by the estimation system using hardware resources such as a CPU and memory built into the computer. The above-described program can be recorded in a computer-readable recording medium (such as a portable memory) to be stored and distributed. Furthermore, the program can also be provided through a network such as the Internet or an electronic mail.

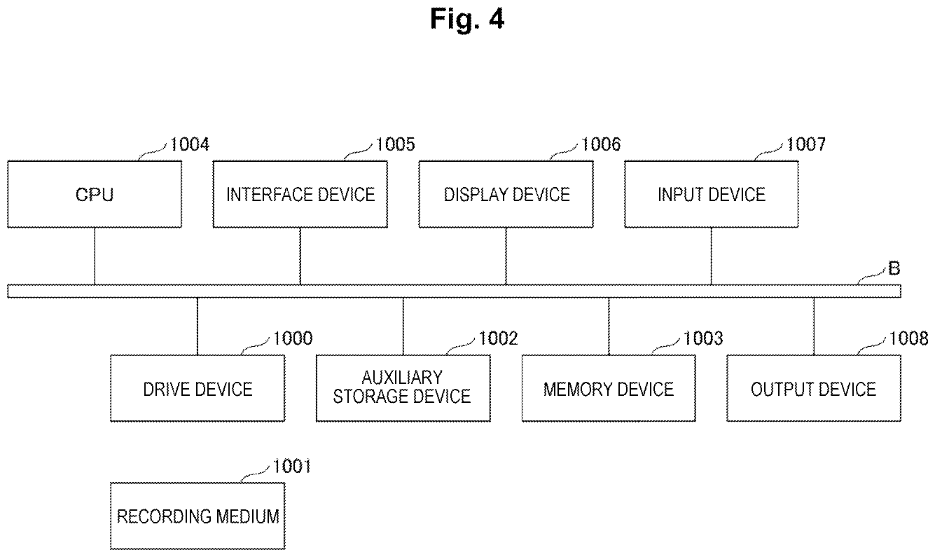

FIG. 4 is a diagram illustrating an exemplified hardware configuration of the computer. The computer in FIG. 4 includes a drive device 1000, an auxiliary storage device 1002, a memory device 1003, a CPU 1004, an interface device 1005, a display device 1006, an input device 1007, an output device 1008, and the like which are connected to one another by a bus BS.

The program for implementing the processing in the computer is provided by, for example, a recording medium 1001 such as a CD-ROM or a memory card. When the recording medium 1001 storing the program is set in the drive device 1000, the program is installed from the recording medium 1001 into the auxiliary storage device 1002 via the drive device 1000. However, the program is not necessarily installed from the recording medium 1001 and may be downloaded from another computer via a network. The auxiliary storage device 1002 stores the installed program and also stores necessary files or data.

When an instruction to start the program is issued, the memory device 1003 reads the program from the auxiliary storage device 1002 and stores the program. The CPU 1004 implements a function related to a light touch retaining device 100 according to the program stored in the memory device 1003. The interface device 1005 is used as an interface for connection to a network, various measurement devices, a motion intervention device, and the like. The display device 1006 displays a graphical user interface (GUI) or the like according to the program. The input device 1007 is formed with a keyboard and a mouse, buttons, a touch panel, or the like, and is used to input various operation instructions. The output device 1008 outputs a calculation result.

### Effects of Embodiment

As described above, in the technology according to the present embodiment, it is possible for even non-professionals to easily and quantitatively estimate the influence of events occurring in the world on companies by utilizing industry correlation analysis and information possessed by a company to calculate the characteristics of business activities that cannot be grasped by mere industry correlation analysis using business transaction information.

### SUPPLEMENTARY NOTES

The present specification discloses an estimation system, an estimation method, and a program of at least the following supplementary items.

### Supplementary Item 1

An estimation system including:

an industry influence calculation unit configured to calculate a production influence amount exerted on a second industry by a change on the basis of change information indicating a change in a first industry in which the change has been observed, a production amount in the second industry to which an evaluation target company belongs, and production inducement information from the first industry to the second industry; and

a business influence calculation unit configured to calculate a sales influence amount exerted on the evaluation target company by the change on the basis of the production influence amount.

### Supplementary Item 2

The estimation system according to item 1, wherein the business influence calculation unit calculates the sales influence amount by using a coefficient of a correlation equation indicating a correlation between a sales amount of the evaluation target company and a production amount in the second industry.

### Supplementary Item 3

The estimation system according to item 2, further including:

an inter-industry correlation calculation unit configured to generate the correlation equation by performing fitting by using past data of a sales amount of the evaluation target company and past data of a production amount in the second industry.

### Supplementary Item 4

The estimation system according to any one of items 1 to 3, further including:

a business influence calculation correction unit configured to correct the sales influence amount by using a value representing a correlation between the evaluation target company and the first industry and a value representing a correlation between the second industry and the first industry.

### Supplementary Item 5

The estimation system according to item 4, wherein the value representing the correlation between the evaluation target company and the first industry is a ratio of a transaction amount between the evaluation target company and the first industry to a total transaction amount of the evaluation target company.

### Supplementary Item 6

An estimation method of executing an estimation system including:

an industry influence calculation step of calculating a production influence amount exerted on a second industry by a change on the basis of change information indicating the change in a first industry in which the change has been observed, a production amount in the second industry to which an evaluation target company belongs, and production inducement information from the first industry to the second industry; and

a business influence calculation step of calculating a sales influence amount exerted on the evaluation target company by the change on the basis of the production influence amount.

### Supplementary Item 7

A program for causing a computer to function as each unit in the estimation system according to any one of Items 1 to 5.

Although the present embodiment has been described above, the present invention is not limited to such a specific embodiment, and various modifications and changes can be made within the scope of the present invention disclosed in the claims.

### Reference Signs List

10 Calculation unit
11 Inter-industry correlation coefficient acquisition unit
12 Inter-industry correlation calculation unit
13 Business transaction correlation calculation unit
14 News information acquisition unit
15 Change amount generation unit
16 Industry influence calculation unit
17 Business influence calculation correction unit
20 Numerical value DB
21 News DB
22 Statistical information DB
23 Company information DB
24 Inter-Industry correlation table DB
25 Industry production amount DB
30 Evaluation equation DB
31 Inter-industry correlation equation DB
32 Business transaction correlation calculation equation DB
33 Industry influence calculation equation DB
34 Business influence correction equation DB
40 Data storage unit
50 Input/output unit
1000 Drive device
1001 Recording medium
1002 Auxiliary storage device
1003 Memory device
1004 CPU
1005 Interface device
1006 Display device
1007 Input device
1008 Output device

1. An estimation system comprising:
a processor; and
a memory that includes instructions, which when executed, cause the processor to execute:
calculating a production influence amount exerted on a second industry by a change based on change information indicating a change in a first industry in which the change has been observed, a production amount in the second industry to which an evaluation target company belongs, and production inducement information from the first industry to the second industry; and
calculating a sales influence amount exerted on the evaluation target company by the change based on the production influence amount.

2. The estimation system according to claim 1, wherein the calculating of the production influence amount includes calculating the sales influence amount by using a coefficient of a correlation equation indicating a correlation between a sales amount of the evaluation target company and a production amount in the second industry.

3. The estimation system according to claim 2, wherein the processor is further caused to execute:
generating the correlation equation by performing fitting by using past data of a sales amount of the evaluation target company and past data of a production amount in the second industry.

4. The estimation system according to claim 1, wherein the processor is further caused to execute:
correcting the sales influence amount by using a value representing a correlation between the evaluation target company and the first industry and a value representing a correlation between the second industry and the first industry.

5. The estimation system according to claim 4, wherein the value representing the correlation between the evaluation target company and the first industry is a ratio of a transaction amount between the evaluation target company and the first industry to a total transaction amount of the evaluation target company.

6. An estimation method of executing an estimation system comprising:
calculating a production influence amount exerted on a second industry by a change based on change information indicating a change in a first industry in which the change has been observed, a production amount in the second industry to which an evaluation target company belongs, and production inducement information from the first industry to the second industry; and
a business influence calculation step of calculating a sales influence amount exerted on the evaluation target company by the change based on the production influence amount.

7. (canceled)

8. A non-transitory computer-readable recording medium having computer-readable instructions stored thereon, which when executed, cause a computer including a memory and a processor to execute the estimation method according to claim 6.
